(19) United States
(12) Patent Application Publication
(10) Pub. No.: US 2024/0345285 A1
(43) Pub. Date: Oct. 17, 2024

(54) SYSTEM AND METHOD FOR AUTOMATED HYDRODYNAMIC SPACE MAPPING TO IDENTIFY FLUID TRAPS WITH IMPROVED SENSITIVITY

(71) Applicant: Saudi Arabian Oil Company, Dhahran (SA)

(72) Inventor: Simon A. Stewart, Dhahran (SA)

(21) Appl. No.: 18/301,756

(22) Filed: Apr. 17, 2023

(51) Int. Cl. G01V 99/00

(52) U.S. Cl. CPC G01V 20/00

(57) ABSTRACT

A computer-implemented method includes: generating a geological structure map for a subsurface of a reservoir; generating a set of tilt maps for the geological structure map, each tilt map representing a hydrodynamic condition in the reservoir; combining each tilt map with the geological structure map so that the geological structure map is recast to generate a set of hydrodynamic structure maps, wherein each hydrodynamic structure map corresponds to a hydrodynamic condition; and identifying one or more closures in each hydrodynamic structure map of the set of hydrodynamic structure maps such that potential hydrodynamic traps in the subsurface of the reservoir are automatically scanned when the set of hydrodynamic structure maps have been scanned, wherein each closure represents a potential hydrodynamic trap in the subsurface where fluid can accumulate under the hydrodynamic gradient.

### TECHNICAL FIELD

This disclosure generally relates to subsurface mapping during reservoir characterization.

### BACKGROUND

Subsurface structures can be mapped for the purposes of finding traps for positively-buoyant fluids such as hydrocarbons and CO₂. Theories have been developed to describe water movement in deep geological reservoirs. Based on the theories (e.g., describing hydraulic head or potential), some practical examples can generate maps of geological structures in the subsurface.

### SUMMARY

In one aspect, the implementations provide a computer-implemented method that includes: generating a geological structure map of an area of interest within a subsurface of a reservoir, wherein the area of interest is defined by a set of spatial coordinates; generating a set of tilt maps for the geological structure map, wherein each tilt map from the set of tilt maps represents a hydrodynamic condition caused by a hydrodynamic gradient in the area of interest of the reservoir; combining each tilt map with the geological structure map so that the geological structure map is recast to generate a set of hydrodynamic structure maps, wherein each hydrodynamic structure map has a corresponding tilt map; and identifying one or more closures in each hydrodynamic structure map of the set of hydrodynamic structure maps such that potential hydrodynamic traps in the subsurface of the reservoir are automatically scanned when the set of hydrodynamic structure maps have been scanned, wherein each closure represents a potential hydrodynamic trap in the subsurface where fluid can accumulate under the hydrodynamic gradient.

Implementations may include one or more of the following features.

The identifying may include: applying a topographic prominence algorithm to the set of hydrodynamic structure maps so that topographic prominence points are identified within a lowest continuous closing contour on each hydrodynamic structure map, wherein the one or more closures are formed by the topographic prominence points, and wherein the one or more closures characterize a distribution of the potential hydrodynamic traps in a hydrodynamic space. The hydrodynamic space may include hydrodynamic coordinates that encompass a first range of hydraulic head gradient magnitudes, a second range of hydraulic head gradient directions, and a third range of tilt amplification factors. The hydrodynamic coordinates may be adjustable based on hydrodynamic measurements from the area of interest. The method may further include: quantifying the one or more closures in each geological structure map of the set of hydrodynamic structure maps; and based on, at least in part, results of the quantifying, ranking the potential hydrodynamic traps in the subsurface of the reservoir. The quantifying may include: generating, for the one or more closures, at least one of: an area metric according to the set of spatial coordinates, a volume metric according to the set of spatial coordinates, or a count of a number of closures. The ranking may include: generating a grade for each hydrodynamic trap of the distribution of the hydrodynamic traps in the hydrodynamic space; and selecting a hydrodynamic trap whose grade is higher than at least one other hydrodynamic trap of the distribution of the hydrodynamic traps in the hydrodynamic space. Fluid in the potential hydrodynamic trap may include at least one of: a positively buoyant fluid, or a negatively buoyant fluid.

In another aspect, implementations provide a computer system comprising one or more hardware computer processors configured to perform operations of: generating a geological structure map of an area of interest within a subsurface of a reservoir, wherein the area of interest is defined by a set of spatial coordinates; generating a set of tilt maps for the geological structure map, wherein each tilt map from the set of tilt maps represents a hydrodynamic condition caused by a hydrodynamic gradient in the area of interest of the reservoir; combining each tilt map with the geological structure map so that the geological structure map is recast to generate a set of hydrodynamic structure maps, wherein each hydrodynamic structure map has a corresponding tilt map; and identifying one or more closures in each hydrodynamic structure map of the set of hydrodynamic structure maps such that potential hydrodynamic traps in the subsurface of the reservoir are automatically scanned when the set of hydrodynamic structure maps have been scanned, wherein each closure represents a potential hydrodynamic trap in the subsurface where fluid can accumulate under the hydrodynamic gradient.

Implementations may provide one or more of the following features.

The identifying may include: applying a topographic prominence algorithm to the set of hydrodynamic structure maps so that topographic prominence points are identified within a lowest continuous closing contour on each hydrodynamic structure map, wherein the one or more closures are formed by the topographic prominence points, and wherein the one or more closures characterize a distribution of the potential hydrodynamic traps in a hydrodynamic space. The hydrodynamic space may include hydrodynamic coordinates that encompass a first range of hydraulic head gradient magnitudes, a second range of hydraulic head gradient directions, and a third range of tilt amplification factors. The hydrodynamic coordinates may be adjustable based on hydrodynamic measurements from the area of interest. The operations may further include: quantifying the one or more closures in each geological structure map of the set of hydrodynamic structure maps; and based on, at least in part, results of the quantifying, ranking the potential hydrodynamic traps in the subsurface of the reservoir. The quantifying may include: generating, for the one or more closures, at least one of: an area metric according to the set of spatial coordinates, a volume metric according to the set of spatial coordinates, or a count of a number of closures. The ranking may include: generating a grade for each hydrodynamic trap of the distribution of the hydrodynamic traps in the hydrodynamic space; and selecting a hydrodynamic trap whose grade is higher than at least one other hydrodynamic trap of the distribution of the hydrodynamic traps in the hydrodynamic space. Fluid in the potential hydrodynamic trap may include at least one of: a positively buoyant fluid, or a negatively buoyant fluid.

In yet another aspect, implementations provide a non-transitory computer-readable medium comprising software instructions that, when executed, cause a computer processor to perform operations of: generating a geological structure map of an area of interest within a subsurface of a reservoir, wherein the area of interest is defined by a set of spatial coordinates; generating a set of tilt maps for the geological structure map, wherein each tilt map from the set of tilt maps represents a hydrodynamic condition caused by a hydrodynamic gradient in the area of interest of the reservoir; combining each tilt map with the geological structure map so that the geological structure map is recast to generate a set of hydrodynamic structure maps, wherein each hydrodynamic structure map has a corresponding tilt map; and identifying one or more closures in each hydrodynamic structure map of the set of hydrodynamic structure maps such that potential hydrodynamic traps in the subsurface of the reservoir are automatically scanned when the set of hydrodynamic structure maps have been scanned, wherein each closure represents a potential hydrodynamic trap in the subsurface where fluid can accumulate under the hydrodynamic gradient.

Implementations may include one or more of the following features.

The identifying may include: applying a topographic prominence algorithm to the set of hydrodynamic structure maps so that topographic prominence points are identified within a lowest continuous closing contour on each hydrodynamic structure map, wherein the one or more closures are formed by the topographic prominence points, and wherein the one or more closures characterize a distribution of the potential hydrodynamic traps in a hydrodynamic space. The hydrodynamic space may include hydrodynamic coordinates that encompass a first range of hydraulic head gradient magnitudes, a second range of hydraulic head gradient directions, and a third range of tilt amplification factors. The hydrodynamic coordinates may be adjustable based on hydrodynamic measurements from the area of interest. The operations may further include: quantifying the one or more closures in each geological structure map of the set of hydrodynamic structure maps; and based on, at least in part, results of the quantifying, ranking the potential hydrodynamic traps in the subsurface of the reservoir. The quantifying may include: generating, for the one or more closures, at least one of: an area metric according to the set of spatial coordinates, a volume metric according to the set of spatial coordinates, or a count of a number of closures. The ranking may include: generating a grade for each hydrodynamic trap of the distribution of the hydrodynamic traps in the hydrodynamic space; and selecting a hydrodynamic trap whose grade is higher than at least one other hydrodynamic trap of the distribution of the hydrodynamic traps in the hydrodynamic space. Fluid in the potential hydrodynamic trap may include at least one of: a positively buoyant fluid, or a negatively buoyant fluid.

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIGS. 1A to 1C illustrate an example to generate an array of hydrodynamic structural maps based on an input map of hydraulic features using automated parameterization according to some implementations of the present disclosure.

FIGS. 2A to 2C illustrate an example of analyzing the array of hydrodynamic structural maps of FIG. 1C using topographic prominence and encirclement criteria according to some implementations of the present disclosure to generate estimated sizes of hydraulic traps.

FIG. 3 shows an example of projecting the estimated sizes of hydraulic traps for improved identification and ranking according to some implementations of the present disclosure.

FIG. 4 is a flow chart illustrating an example according to some implementations of the present disclosure.

FIG. 5 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

Hydrodynamic traps for fluids in subsurface reservoirs, and modification of structural traps by hydrodynamic reservoir conditions, can be difficult to identify at least because well data and reservoir pressure information are generally limited in most exploration situations distant from data-rich areas such as hydrocarbon fields. While prior art has developed methodologies that describe the range of possible hydrodynamic reservoir conditions, nothing exists to identify and quantify the potential volume of hydrodynamically trapped fluids in subsurface reservoirs for an extended region. For example, some prior art describes the theory and practical examples of water movement in deep geological reservoirs. Other prior art describes methods to adjust maps of geological structure to account for the effects of reservoir water flow upon fluid contacts, thereby effectively imposing local reference frame rotations on the structural map such that tilted contacts are represented as flat and the resulting traps can be easily seen on the transformed map. However, these map transformations are based on a relatively time-consuming exercise predicated on the existence of reservoir pressure measurements with which to transform the structural map. In many exploration settings, pressure data may be unavailable, along with information about reservoir quality, thereby introducing significant uncertainty and degrading the value of time vested on implementing the workflow. Prior art additionally describes hydraulic head (e.g., hydraulic potential) conditions can be simplified to a locally-planar surface that can be manipulated interactively in terms of inclination and azimuth to search the range of hydrodynamic possibilities (termed as “hydrodynamic space”). Hydrodynamic space also has a third dimension in addition to hydraulic head gradient and azimuth, namely the “tilt amplification factor,” which represents the density contrast between the fluids at hand (those fluids being the fluid that regionally fills the pore space in a reservoir e.g. water or brine, and the potentially trapped fluid e.g. oil or CO₂). However, the search remains a manual method prone to subjective determinations by operators.

To address the technical challenge, implementations of the present disclosure can automatically parameterize the hydrodynamic conditions so that the ranges of parameters can, in applications, represent the range of uncertainty in those parameters. In the parameterized hydrodynamic space, implementations of the present disclosure can generate an array of separate hydrodynamic structure maps. The implementations may then analyze these hydrodynamic structure maps and determine the potential volume of fluids trapped hydrodynamically. The implementations can automate this parameterization of hydrodynamic space by generating ranges of hydrodynamic conditions according to the ranges of hydrodynamic space parameters. In a further step of automation, each realized hydrodynamic condition so generated can be subjected to topographic prominence algorithms that incorporate spatial distribution techniques to characterize the distribution of hydrodynamic traps in the hydrodynamic space with a degree of resolution scalable by available computing resources. Such combinations can yield unprecedented abilities to identify and compare the potential volume of fluids trapped hydrodynamically in a region of interest, which can encompass a large geologic region for oil and gas exploration and accommodate considerable uncertainties in the input parameters such as hydraulic head gradient and azimuth, which are typically poorly constrained in exploration situations. The implementations can also rank the hydrodynamic trap populations in relation to the hydrodynamic space parameters with improved computational efficiency when searching for hydrocarbons in areas of low topographic relief and when modelling the dynamics of CO₂ plumes in sedimentary basins. In other words, implementations of the present disclosure can parameterize the search of hydrodynamic space such that scanning hydrodynamic space can be automated. By contrast, known prior art methods describing the range of possible hydrodynamic reservoir conditions would only lead to an exhaustive search (e.g., manual search) of the entire hydrodynamic space that encompasses all possible hydrodynamic structural maps.

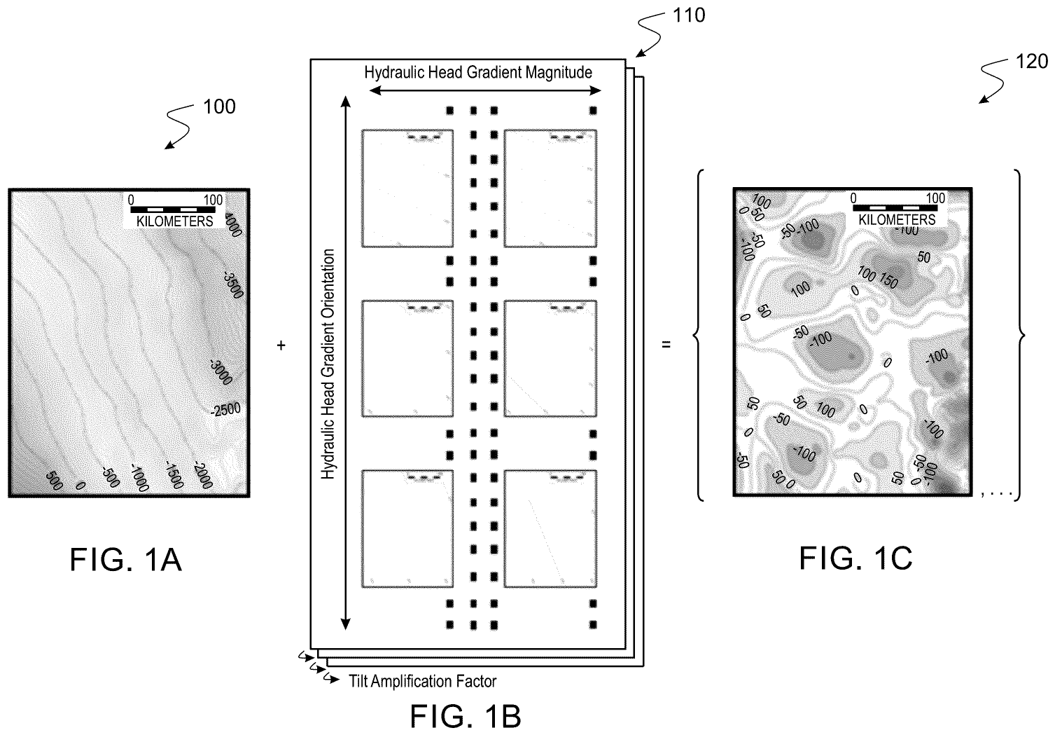

Although some examples can map subsurface structures for the purposes of finding traps for positively buoyant fluids such as hydrocarbons and supercritical CO₂, the implementations can be applied to negatively buoyant fluids such as chemical waste and dissolved CO₂. Indeed, the implementations are generally applicable to sedimentary basins where the geology is arranged into rock layers that control the distribution and movements of fluids through the porosity systems. In some cases, the implementations can automate the assessment of the effects of hydrodynamic gradients that alter trap configurations in the reservoirs. The implementations can automatically identify traps using topographic prominence and closing contour criteria. The identified traps can be analyzed in relation to the hydrodynamic space parameters by various spatial distribution algorithms. Details of the implementations are provided below, in association with FIGS. 1A-1C, 2A-2C, and 3-5.

In more detail, FIG. 1A shows an example of a structural map 100. On this structural map 100, each pixel represents a point in depth of a given geological horizon such as a bedding layer or a distinctive layer within a reservoir (specifically in this case but not necessarily the top of a reservoir). In this example, where north is up, the structure of the represented horizon becomes deeper to the northeast. For this reason, the reservoir “dips” to the northeast, as described in the parlance of geophysics.

In the context of geo-exploration and reservoir characterization, a hydraulic head, which refers to the hydraulic the potential energy of, e.g., groundwater at a specific location in the subsurface relative to a reference elevation, can drive the movement of fluid parallel to the top and base boundaries of reservoirs. This movement results in tilt of the contact between the moving fluid and locally-trapped fluid that is separated from the main body of reservoir fluid by, e.g., immiscibility, density contrast or other property. As demonstrated in prior art, the magnitude of this tilt generally can be in proportion to the hydraulic head gradient and in inverse proportion to the density contrast between the two fluid bodies. This relationship can give rise to a range of possible hydrodynamic structures when, for example, the hydrodynamic effect is represented as a locally planar surface oriented according to the hydraulic head vector (i.e. maximum hydraulic gradient and its direction). The magnitude and direction of the hydraulic head, together with an additional parameter representing fluid density contrast (e.g., the tilt amplification factor, usually formulated as ρ_{w}/(ρ_{w}−ρₒ), where ρ_{w} is reservoir water density and ρₒ is density of the immiscible fluid e.g. oil), can define the range of possible hydrodynamic structures. Using these three parameters, termed as “hydrodynamic coordinates” in the present disclosure, a “hydrodynamic space” can be formed to include the possible hydrodynamic conditions in a reservoir. Each dimension of hydrodynamic space, namely, hydraulic head gradient, orientation, and tilt amplification factor, is continuous therefore the hydrodynamic space can yield an infinite set of hydrodynamic structures for a single depth structure. This parameterization can provide a theoretic framework for improved data analytics.

In practice, the set of hydrodynamic conditions are constrained by the range and sampling interval utilized when populating the hydrodynamic space. Ranges of hydraulic head gradient can be derived from available information about the hydrodynamics of the sedimentary basin surrounding the area of interest. In cases where such information is unavailable, an appropriate range can be determined on an ad-hoc basis by person of ordinary skill in the art. For instance, hydraulic head gradients, in many cases, are on the order of 1 m per km where the reservoir is confined and open to recharge and/or discharge. The range of orientation (azimuth) of hydraulic head gradient again may be delimited by available information. When the information is not available, the direction in relation to reservoir configuration can also be determined cases-by-case. In some instances, the range of orientations can be left very wide or even fully open to the maximum range of 0-360 degrees. The tilt amplification factor is constrained by the density of the fluid that fills most of the reservoir, typically water or brine of a given salinity, and the target fluid that may be hydrodynamically trapped, for instance hydrocarbons or CO₂. Tilt amplification factors in the range 4-10 are typical for oil-brine systems. Here again, the ranges can be selected to accommodate uncertainties in available information. Finally, the choice of sampling interval determines how finely-subdivided the hydrodynamic space will be when searching for hydrodynamic traps. This is limited only by computing resources.

In this context, FIG. 1B shows an array 110 of maps that represent the hydrodynamic conditions in the reservoir whose structure map 100 is shown in FIG. 1A. In this example, this array is organized according to variations in hydraulic head gradient (horizontal axis), and the direction in which the gradient varies (vertical axis). In some applications, the description of spatial variation in hydraulic head is known as “potentiometric surface” or “piezometric surface.” The two parameters on the axes of FIG. 1B are termed “hydrodynamic space coordinates,” as used in the present disclosure. These two parameters (coordinates) may be constrained by available data such as well fluid pressures. In cases where constraining data is unavailable, the geological structure can be fitted with a planar first order trend surface as an estimate of the orientation parameter. For example, prior art has shown that 1 meter per kilometer can form an estimated gradient. Variations in these parameters can reflect the uncertainty in the parameter values. The array can be large enough to handle large uncertainties since the process can be fully automated. The array can have an additional dimension, the tilt amplification factor parameter, which has been described above. Each map in the array representing a specific hydrodynamic condition can form a datum relative to which the geological structure (e.g., shown in FIG. 1A) can be recast to reveal the hydrodynamic structure (e.g., as shown in FIG. 1C).

FIG. 1C shows the result of adding the geological structure in FIG. 1A to one instance of a map of hydrodynamic conditions from FIG. 1B. The resulting structure 120 is a “hydrodynamic structure” and can be displayed with vertical units in the same depth units as the geological structure for instance meters or feet. Each pixel in structure 120 of FIG. 1C represents a point in depth of top reservoir in a specific scenario of hydrodynamic parameters (“coordinates in hydrodynamic space” in the parlance developed in the disclosure). Note that the depth values in FIG. 1C are relative not absolute because in FIG. 1A the depth units are relative to a well-known datum such as Mean Sea Level whereas the depth units in FIG. 1C are relative to a specific realization of the hydrodynamic conditions drawn from the array in FIG. 1B. Although only one map of hydrodynamic structure is shown, the resulting set can be very large, for instance hundreds or thousands, depending on the definition of ranges of hydrodynamic space dimensions and the sampling interval.

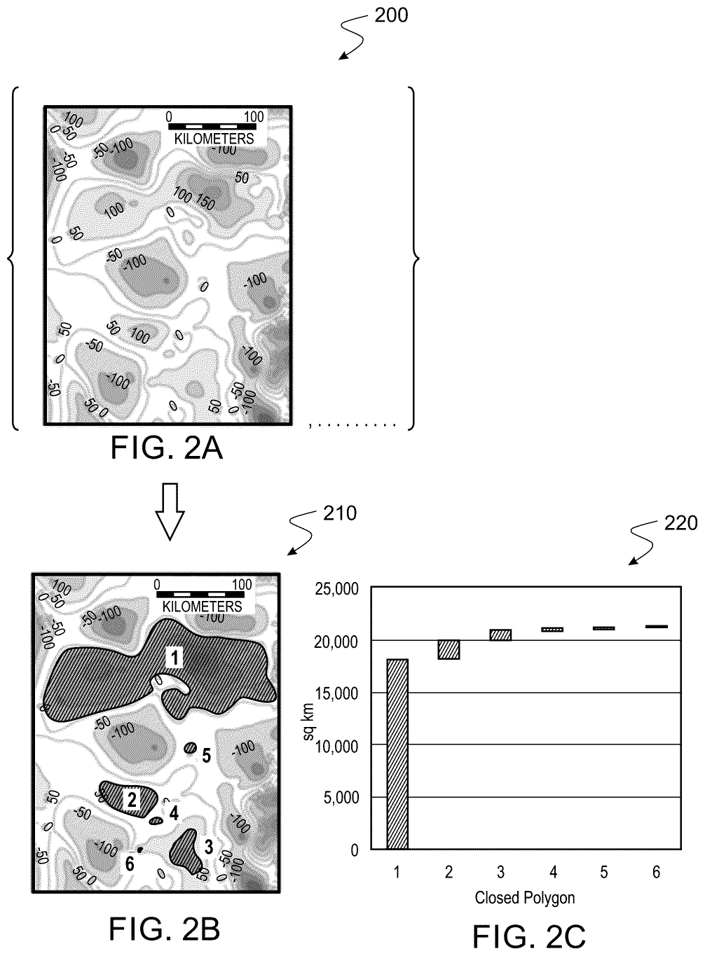

Once the array of hydrodynamic structure maps are available, implementations can apply topographic prominence algorithms coupled with, for example, lowest continuous closing contour approaches. Examples of the topographic prominence can identify points of topographic prominence where prominence is the difference between the elevation of a point, and the elevation of the lowest contour line that contains the point with no higher point inside. Examples of algorithms that yield this information can include the Morse-Smale topology and deep learning approaches. Because the lowest contour defines the area of the trap, the lowest closing contour line is of primary interest in the present disclosure. More specifically, in various implementations of the present disclosure, the lowest contour line for a single trap is continuous within the spatial limits of the area of interest, as revealed in diagram 200 of FIG. 2A.

Although contours that partially enclose structural highs but are truncated by the boundaries of the area of interest may exist in the hydrodynamic structural realization, these contours extend outside the specified area of interest. Because these contours do not in fact completely encircle the given structural high, these contours are generally excluded. This truncation of trap population may be overridden by extending the area of interest with additional mapping if available. Large traps defined on this basis may have more than one closed culmination within the lowest encircling contour, as seen in polygon 1 of FIG. 2B. This appearance is normal in large structural traps and double counting of closures can be avoided. Each closure or trap thus identified can then be characterized by parameters including area, location coordinates of the highest point, volume (when reservoir thickness is known), a volume range (when the reservoir thickness is not known), and other parameters. Each closure or trap is linked to the “hydrodynamic coordinates” (i.e. hydraulic head gradient and orientation, and tilt amplification factor) that specify the realization in which the closure is identified. This information is collected in a data array that can be presented or analyzed in a variety of ways. For example, a total of six closures or traps, namely, polygons 1 to 6, are shown in diagram 210 of FIG. 2B.

FIG. 2C shows the bar chart 220 of the areas for the six closures or traps. The offsets in the accompanying graphical display corresponding to a stacked column display with each element separated on the x-axis (the horizontal axis). Such display format may facilitate easy visual access the total amount of area or volume depicted on the chart.

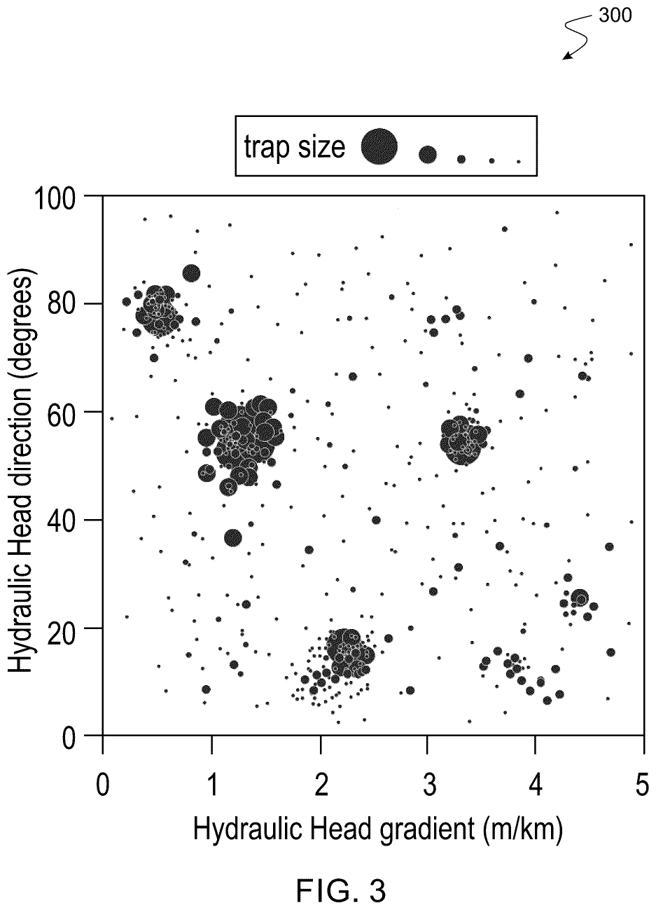

The process of trap identification outlined in relation to FIGS. 2A to 2C can be repeated for each hydrodynamic structure map generated from parameters sampled from hydrodynamic space as outlined in FIGS. 1A to 1C. This automated procedure can generate an array of traps defined in relation to hydrodynamic coordinates, which can enable a full description of the hydrodynamic trap potential in relation to the hydrodynamic space defined above. This array of results can be charted in relation to hydrodynamic coordinates, as shown in diagram 300 of FIG. 3.

While FIG. 3 shows the results plotted in terms of hydraulic head gradient and orientation, a tilt amplification factor axis can be used instead, or in addition, if 3D charts are preferred. The information presented in this way can be inspected visually with case by an operator. In some cases, the output step can also be automated by applying spatial distribution characterization such as nearest neighbor analysis, correlation length analysis and minimal spanning tree analysis, as may be used in the fields of ecology and astronomy. A clustering analysis of this type can yield a compact output of high-graded coordinates in the hydrodynamic space for trapping potential.

The hydrodynamic coordinates thus prioritized can then be used to launch additional steps such as well localization and data acquisition to verify the robustness of the realizations (e.g., FIG. 1B) and in turn support, modify or reject proposed exploration projects. In many cases, the implementations can provide timeline optimization and cost avoidance for hydrocarbon exploration or CO₂ storage projects. In the case of hydrocarbon exploration, the implementations could also lead to the discovery of otherwise overlooked hydrocarbon accumulations.

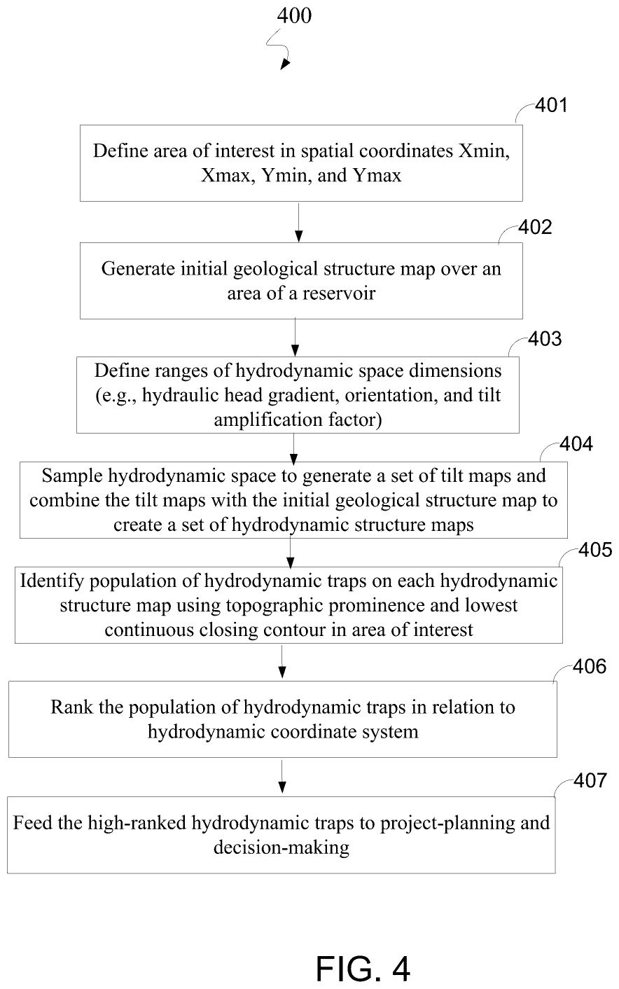

FIG. 4 is a flow chart 400 illustrating an example of a process according to some implementations of the present disclosure. The process may define an area of interest within a horizon of a reservoir (401). For example, the area of interest may cover ranges in two orthogonal directions (e.g., from x_min to x_max on the x-axis, and from y_min to y_max on the y-axis). As discussed above, the area of interest may be defined large enough to cover regions of the reservoir where trapped fluid in the subsurface are desired to be quantified or estimated.

The process may then generate an initial geological structure map over the defined area of the reservoir (402). This geological structure map may be a representation of the subsurface geological structures in a given area, an example of which is illustrated in map 100 of FIG. 1A. Each pixel of the geological structure map may represent a point in depth of a given geological horizon (e.g., a bedding or a layer of the reservoir). Implementations may use data from geological fieldwork, satellite imagery, geophysical techniques to generate the geological structure map.

The process may then define ranges of hydrodynamic space dimensions (403). As discussed above in association with FIG. 1B, the implementations can form a “hydrodynamic space” based on “hydrodynamic coordinates” using parameters of, e.g., hydraulic head gradient, orientation and tilt amplification factor.

The process may then sample the hydrodynamic space to generate a set of tilt maps and combined the tilt maps with the geological structure map to create a set of hydrodynamic structure maps (404). For example, an array 110 of FIG. 1B include maps of hydrodynamic conditions organized according to variations in hydraulic head gradient (horizontal axis), and the direction in which the gradient varies (vertical axis). Each map in the array representing a specific hydrodynamic condition can form a datum relative to which the geological structure (e.g., shown in FIG. 1A) can be recast to reveal the hydrodynamic structure (e.g., as shown in FIG. 1C). An example of a hydrodynamic structure is shown in FIG. 1C. As discussed above, implementations can generate multiple instances of hydrodynamic structures, depending on the definition of ranges of hydrodynamic space dimensions and the sampling interval.

The process may then identify populations of hydrodynamic traps on each hydrodynamic structure of the set of hydrodynamic structures (405). The implementations may incorporate topographic prominence algorithms coupled with, for example, lowest continuous closing contour approaches so that polygons that correspond to populations of hydrodynamic traps can be identified in the hydrodynamic space, as shown in FIG. 2B. As an example output, the areas of the polygons on each hydrodynamic structure can be computed. An example is shown in chart 220 in FIG. 2C. Traps could be parameterized in other ways, for instance, by volume (if reservoir thickness and porosity parameters are known).

The areas of populations of hydrodynamic traps, as identified on each hydrodynamic structure of the set of hydrodynamic structures and clustered around hydrodynamic coordinates, can be ranked (406). In some cases, ranking refers to ranking trap areas or volumes according to size, or the number of traps at or near a specific hydrodynamic coordinate. Other ranking parameters in relation to spatial location or regional geological parameters such as reservoir quality can also be visualized. The ranking in relation to hydrodynamic space can be adjusted by an operator, for example, to adapt to a particular application scenario. For instance, the implementations can rank the identified traps in relation to a combination of one, two or three hydrodynamic coordinates. Some implementations may also apply a “hydrodynamic space tolerance” parameter, namely the number of traps or summed trap volume that exist within a specific hydrodynamic set of conditions, or ranges of uncertainty.

The process may feed information of the ranked hydrodynamic structure traps to on-going project planning and decision-making (407). In some cases, the ranked hydrodynamic traps can be evaluated on the basis of the corresponding distribution or clustering in hydrodynamic space, to automatically yield the most promising hydrodynamic conditions, which can then be targeted by programs for verification of the identified findings.

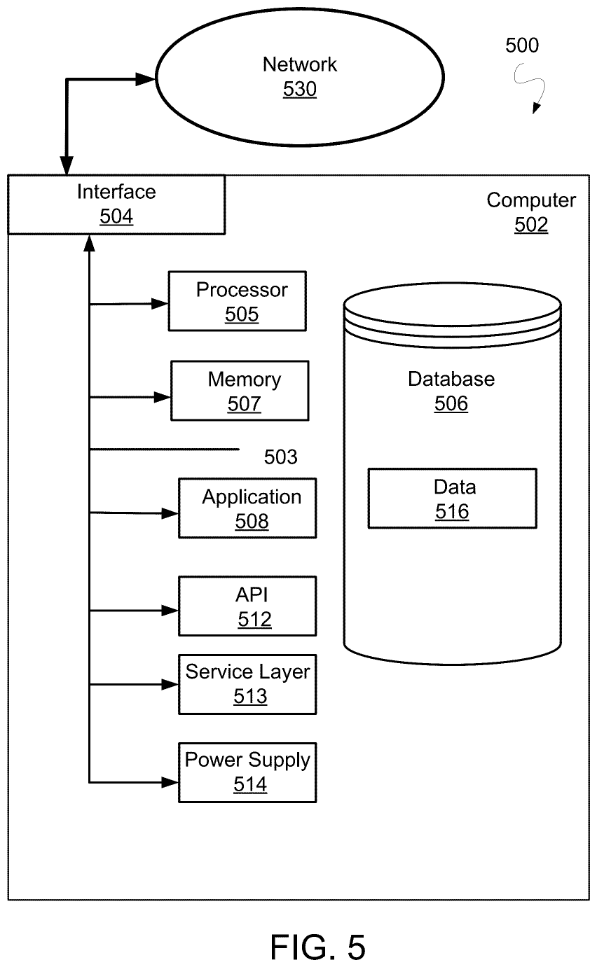

FIG. 5 is a block diagram 500 illustrating an example of a computer system 500 used to provide computational functionalities associated with described algorithms, methods, functions, processes, flows, and procedures, according to an implementation of the present disclosure. The illustrated computer 502 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 502 can comprise a computing device that includes an input device, such as a keypad, keyboard, touch screen, another input device, or a combination of input devices that can accept user information, and an output device that conveys information associated with the operation of the computer 502, including digital data, visual, audio, another type of information, or a combination of types of information, on a graphical-type user interface (UI) (or GUI) or other UI.

The computer 502 can serve in a role in a computer system as a client, network component, a server, a database or another persistency, another role, or a combination of roles for performing the subject matter described in the present disclosure. The illustrated computer 502 is communicably coupled with a network 530. In some implementations, one or more components of the computer 502 can be configured to operate within an environment, including cloud-computing-based, local, global, another environment, or a combination of environments.

The computer 502 is an electronic computing device operable to receive, transmit, process, store, or manage data and information associated with the described subject matter. According to some implementations, the computer 502 can also include or be communicably coupled with a server, including an application server, e-mail server, web server, caching server, streaming data server, another server, or a combination of servers.

The computer 502 can receive requests over network 530 (for example, from a client software application executing on another computer 502) and respond to the received requests by processing the received requests using a software application or a combination of software applications. In addition, requests can also be sent to the computer 502 from internal users, external or third-parties, or other entities, individuals, systems, or computers.

Each of the components of the computer 502 can communicate using a system bus 503. In some implementations, any or all of the components of the computer 502, including hardware, software, or a combination of hardware and software, can interface over the system bus 503 using an application programming interface (API) 512, a service layer 513, or a combination of the API 512 and service layer 513. The API 512 can include specifications for routines, data structures, and object classes. The API 512 can be either computer-language independent or dependent and refer to a complete interface, a single function, or even a set of APIs. The service layer 513 provides software services to the computer 502 or other components (whether illustrated or not) that are communicably coupled to the computer 502. The functionality of the computer 502 can be accessible for all service consumers using this service layer. Software services, such as those provided by the service layer 513, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 502, alternative implementations can illustrate the API 512 or the service layer 513 as stand-alone components in relation to other components of the computer 502 or other components (whether illustrated or not) that are communicably coupled to the computer 502. Moreover, any or all parts of the API 512 or the service layer 513 can be implemented as a child or a sub-module of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502. The interface 504 is used by the computer 502 for communicating with another computing system (whether illustrated or not) that is communicatively linked to the network 530 in a distributed environment. Generally, the interface 504 is operable to communicate with the network 530 and comprises logic encoded in software, hardware, or a combination of software and hardware. More specifically, the interface 504 can comprise software supporting one or more communication protocols associated with communications such that the network 530 or interface's hardware is operable to communicate physical signals within and outside of the illustrated computer 502.

The computer 502 includes a processor 505. Although illustrated as a single processor 505 in FIG. 5, two or more processors can be used according to particular needs, desires, or particular implementations of the computer 502. Generally, the processor 505 executes instructions and manipulates data to perform the operations of the computer 502 and any algorithms, methods, functions, processes, flows, and procedures as described in the present disclosure.

The computer 502 also includes a database 506 that can hold data for the computer 502, another component communicatively linked to the network 530 (whether illustrated or not), or a combination of the computer 502 and another component. For example, database 506 can be an in-memory, conventional, or another type of database storing data consistent with the present disclosure. In some implementations, database 506 can be a combination of two or more different database types (for example, a hybrid in-memory and conventional database) according to particular needs, desires, or particular implementations of the computer 502 and the described functionality. Although illustrated as a single database 506 in FIG. 5, two or more databases of similar or differing types can be used according to particular needs, desires, or particular implementations of the computer 502 and the described functionality. While database 506 is illustrated as an integral component of the computer 502, in alternative implementations, database 506 can be external to the computer 502. As illustrated, the database 506 holds data 516 including, for example, data encoding the geological structure maps, the instances of tilt maps, and the corresponding hydrodynamic structure maps, as explained in more detail in association with FIGS. 1A-1C, 2A-2C, and 3-4.

The computer 502 also includes a memory 507 that can hold data for the computer 502, another component or components communicatively linked to the network 530 (whether illustrated or not), or a combination of the computer 502 and another component. Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 or similar or differing types can be used according to particular needs, desires, or particular implementations of the computer 502 and the described functionality. While memory 507 is illustrated as an integral component of the computer 502, in alternative implementations, memory 507 can be external to the computer 502.

The application 508 is an algorithmic software engine providing functionality according to particular needs, desires, or particular implementations of the computer 502, particularly with respect to functionality described in the present disclosure. For example, application 508 can serve as one or more components, modules, or applications. Further, although illustrated as a single application 508, the application 508 can be implemented as multiple applications 508 on the computer 502. In addition, although illustrated as integral to the computer 502, in alternative implementations, the application 508 can be external to the computer 502.

The computer 502 can also include a power supply 514. The power supply 514 can include a rechargeable or non-rechargeable battery that can be configured to be either user-or non-user-replaceable. In some implementations, the power supply 514 can include power-conversion or management circuits (including recharging, standby, or another power management functionality). In some implementations, the power-supply 514 can include a power plug to allow the computer 502 to be plugged into a wall socket or another power source to, for example, power the computer 502 or recharge a rechargeable battery.

There can be any number of computers 502 associated with, or external to, a computer system containing computer 502, each computer 502 communicating over network 530. Further, the term “client,” “user,” or other appropriate terminology can be used interchangeably, as appropriate, without departing from the scope of the present disclosure. Moreover, the present disclosure contemplates that many users can use one computer 502, or that one user can use multiple computers 502.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
generating a geological structure map of an area of interest within a subsurface of a reservoir, wherein the area of interest is defined by a set of spatial coordinates;
generating a set of tilt maps for the geological structure map, wherein each tilt map from the set of tilt maps represents a hydrodynamic condition caused by a hydrodynamic gradient in the area of interest of the reservoir;
combining each tilt map with the geological structure map so that the geological structure map is recast to generate a set of hydrodynamic structure maps, wherein each hydrodynamic structure map has a corresponding tilt map; and
identifying one or more closures in each hydrodynamic structure map of the set of hydrodynamic structure maps such that potential hydrodynamic traps in the subsurface of the reservoir are automatically scanned when the set of hydrodynamic structure maps have been scanned, wherein each closure represents a potential hydrodynamic trap in the subsurface where fluid can accumulate under the hydrodynamic gradient.

2. The computer-implemented method of claim 1, wherein said identifying comprises:
applying a topographic prominence algorithm to the set of hydrodynamic structure maps so that topographic prominence points are identified within a lowest continuous closing contour on each hydrodynamic structure map, wherein the one or more closures are formed by the topographic prominence points, and wherein the one or more closures characterize a distribution of the potential hydrodynamic traps in a hydrodynamic space.

3. The computer-implemented method of claim 2, wherein the hydrodynamic space comprises hydrodynamic coordinates that encompass a first range of hydraulic head gradient magnitudes, a second range of hydraulic head gradient directions, and a third range of tilt amplification factors, and wherein the hydrodynamic coordinates are adjustable based on hydrodynamic measurements from the area of interest.

4. The computer-implemented method of claim 3, further comprising:
quantifying the one or more closures in each geological structure map of the set of hydrodynamic structure maps; and
based on, at least in part, results of the quantifying, ranking the potential hydrodynamic traps in the subsurface of the reservoir.

5. The computer-implemented method of claim 4, wherein said quantifying comprises:
generating, for the one or more closures, at least one of: an area metric according to the set of spatial coordinates, a volume metric according to the set of spatial coordinates, or a count of a number of closures.

6. The computer-implemented method of claim 4, wherein said ranking comprises:
generating a grade for each hydrodynamic trap of the distribution of the hydrodynamic traps in the hydrodynamic space; and
selecting a hydrodynamic trap whose grade is higher than at least one other hydrodynamic trap of the distribution of the hydrodynamic traps in the hydrodynamic space.

7. The computer-implemented method of claim 1, wherein fluid in the potential hydrodynamic trap comprises at least one of: a positively buoyant fluid, or a negatively buoyant fluid.

8. A computer system comprising one or more hardware computer processors configured to perform operations of:
generating a geological structure map of an area of interest within a subsurface of a reservoir, wherein the area of interest is defined by a set of spatial coordinates;
generating a set of tilt maps for the geological structure map, wherein each tilt map from the set of tilt maps represents a hydrodynamic condition caused by a hydrodynamic gradient in the area of interest of the reservoir;
combining each tilt map with the geological structure map so that the geological structure map is recast to generate a set of hydrodynamic structure maps, wherein each hydrodynamic structure map has a corresponding tilt map; and
identifying one or more closures in each hydrodynamic structure map of the set of hydrodynamic structure maps such that potential hydrodynamic traps in the subsurface of the reservoir are automatically scanned when the set of hydrodynamic structure maps have been scanned, wherein each closure represents a potential hydrodynamic trap in the subsurface where fluid can accumulate under the hydrodynamic gradient.

9. The computer system of claim 8, wherein said identifying comprises:
applying a topographic prominence algorithm to the set of hydrodynamic structure maps so that topographic prominence points are identified within a lowest continuous closing contour on each hydrodynamic structure map, and wherein the one or more closures are formed by the topographic prominence points, and wherein the one or more closures characterize a distribution of the potential hydrodynamic traps in a hydrodynamic space.

10. The computer system of claim 9, wherein the hydrodynamic space comprises hydrodynamic coordinates that encompass a first range of hydraulic head gradient magnitudes, a second range of hydraulic head gradient directions, and a third range of tilt amplification factors, and wherein the hydrodynamic coordinates are adjustable based on hydrodynamic measurements from the area of interest.

11. The computer system of claim 10, wherein the operations further comprise:
quantifying the one or more closures in each geological structure map of the set of hydrodynamic structure maps; and
based on, at least in part, results of the quantifying, ranking the potential hydrodynamic traps in the subsurface of the reservoir.

12. The computer system of claim 11, wherein said quantifying comprises:
generating, for the one or more closures, at least one of: an area metric according to the set of spatial coordinates, a volume metric according to the set of spatial coordinates, or a count of a number of closures.

13. The computer system of claim 11, wherein said ranking comprises:
generating a grade for each hydrodynamic trap of the distribution of the hydrodynamic traps in the hydrodynamic space; and
selecting a hydrodynamic trap whose grade is higher than at least one other hydrodynamic trap of the distribution of the hydrodynamic traps in the hydrodynamic space.

14. The computer system of claim 8, wherein fluid in the potential hydrodynamic trap comprises at least one of: a positively buoyant fluid, or a negatively buoyant fluid.

15. A non-transitory computer-readable medium comprising software instructions that, when executed, cause a computer processor to perform operations of:
generating a geological structure map of an area of interest within a subsurface of a reservoir, wherein the area of interest is defined by a set of spatial coordinates;
generating a set of tilt maps for the geological structure map, wherein each tilt map from the set of tilt maps represents a hydrodynamic condition caused by a hydrodynamic gradient in the area of interest of the reservoir;
combining each tilt map with the geological structure map so that the geological structure map is recast to generate a set of hydrodynamic structure maps, wherein each hydrodynamic structure map has a corresponding tilt map; and
identifying one or more closures in each hydrodynamic structure map of the set of hydrodynamic structure maps such that potential hydrodynamic traps in the subsurface of the reservoir are automatically scanned when the set of hydrodynamic structure maps have been scanned, wherein each closure represents a potential hydrodynamic trap in the subsurface where fluid can accumulate under the hydrodynamic gradient.

16. The non-transitory computer-readable medium of claim 15, wherein said identifying comprises:
applying a topographic prominence algorithm to the set of hydrodynamic structure maps so that topographic prominence points are identified within a lowest continuous closing contour on each hydrodynamic structure map, and wherein the one or more closures are formed by the topographic prominence points, and wherein the one or more closures characterize a distribution of the potential hydrodynamic traps in a hydrodynamic space.

17. The non-transitory computer-readable medium of claim 16, wherein the hydrodynamic space comprises hydrodynamic coordinates that encompass a first range of hydraulic head gradient magnitudes, a second range of hydraulic head gradient directions, and a third range of tilt amplification factors, and wherein the hydrodynamic coordinates are adjustable based on hydrodynamic measurements from the area of interest.

18. The non-transitory computer-readable medium of claim 17, wherein the operations further comprise:
quantifying the one or more closures in each geological structure map of the set of hydrodynamic structure maps; and
based on, at least in part, results of the quantifying, ranking the potential hydrodynamic traps in the subsurface of the reservoir.

19. The non-transitory computer-readable medium claim 18, wherein said quantifying comprises:
generating, for the one or more closures, at least one of: an area metric according to the set of spatial coordinates, a volume metric according to the set of spatial coordinates, or a count of a number of closures.

20. The non-transitory computer-readable medium of claim 18, wherein said ranking comprises:
generating a grade for each hydrodynamic trap of the distribution of the hydrodynamic traps in the hydrodynamic space; and
selecting a hydrodynamic trap whose grade is higher than at least one other hydrodynamic trap of the distribution of the hydrodynamic traps in the hydrodynamic space.
